(19) United States
(12) Patent Application Publication
(10) Pub. No.: US 2024/0157445 A1
(43) Pub. Date: May 16, 2024

(54) TECHNIQUE FOR REMOVING POWDER AND/OR PARTICLES FROM A POWDER BED

(71) Applicant: Nikon SLM Solutions AG, Luebeck (DE)

(72) Inventors: Daniel Kopschinski, Luebeck (DE); Christian Mueller, Luebeck (DE)

(21) Appl. No.: 18/281,808

(22) PCT Filed: Apr. 20, 2022
(86) PCT No.: PCT/EP2022/060400

§ 371 Date: Sep. 13, 2023

(30) Foreign Application Priority Data
Apr. 21, 2021 (DE) 10 2021 110 084.4

(51) Int. Cl. B22F 10/50; B22F 10/28; B22F 10/73; B22F 12/70; B33Y 30/00; B33Y 40/00

(52) U.S. Cl. CPC B22F 10/50; B22F 10/28; B22F 10/73; B22F 12/70; B33Y 30/00; B33Y 40/00

(57) ABSTRACT

The invention relates to a device for removing powder and/or particles from a powder bed. The device comprises a rotatably mounted roller having a porous outer wall and comprises a plurality of chambers formed inside the roller. The device also comprises a connection for negative-pressure supply that is designed to supply at least one of the chambers with negative pressure at a given point in time. The at least one of the chambers has an opening which is suitable for supplying the chamber with negative pressure.

The invention relates to an apparatus and a method for removing powder and/or particles from a powder bed. The presented technique can be used in particular in connection with selective electron beam melting, selective laser melting or selective laser sintering in order to remove a defined amount of powder from the powder bed.

In generative processes for the production of three-dimensional workpieces and, in particular, in generative layer construction processes, it is known that an initially shapeless or shape-neutral molding compound of a raw material (for example, a raw material powder) is applied layer by layer to a carrier and solidified by site-specific irradiation (e.g., by fusing or sintering) in order to ultimately obtain a workpiece of a desired shape. The irradiation can be carried out by means of electromagnetic radiation, for example in the form of electron or laser radiation. In an initial state, the molding compound may initially be in the form of granules, powder or liquid molding compound and, as a result of the irradiation, may be selectively or, in other words, site-specifically solidified. The molding compound can comprise, for example, ceramic, metal or plastic materials and also material mixtures thereof. One variant of generative layer construction processes relates to so-called laser beam melting in a powder bed, in which in particular metallic and/or ceramic raw material powder materials are solidified into three-dimensional workpieces under irradiation of a laser beam.

For the production of individual workpiece layers, it is also known to apply raw material powder material in the form of a raw material powder layer to a carrier and to irradiate it selectively and in accordance with the geometry of the workpiece layer currently to be produced. The laser radiation penetrates into the raw material powder material and solidifies it, for example as a result of heating, which causes melting or sintering. Once a workpiece layer is solidified, a new layer of unprocessed raw material powder material is applied to the already produced workpiece layer. Known coater arrangements or powder application devices can be used for this purpose. Subsequently, the now uppermost and still unprocessed raw material powder layer is irradiated again. Consequently, the workpiece is built up successively layer by layer, each layer defining a cross-sectional area and/or a contour of the workpiece. In this context, it is also known to make use of CAD or comparable workpiece data in order to manufacture the workpieces essentially automatically.

It is understood that within the scope of the present invention, all of the aspects explained above may also be provided.

Furthermore, it is known that at least two materials can be combined in a build job so that a workpiece can be produced which consists of these at least two materials.

This is done in particular by alternately applying the powder layers of the different materials. If the individual materials are applied over the entire layer, the unsolidified part of the previous powder layer of the other material must be removed before the new coating is applied. It is desirable to remove the powder of the previous layer as completely as possible to avoid contamination of the subsequently newly applied powder.

Currently, it is known to suck off the previous layer with a funnel. However, this step is usually performed in an undefined manner and with powder loss. This powder loss can mean that powder has to be added, for example with a quantity factor of 100. If powder mixture is extracted 3 mm deep for every 30 μm layer, with a component with a cylinder volume of 1|=100| of scrap powder, or mixed powder is produced, which subsequently can no longer be used or must be reprocessed in a laborious manner (e.g. cleaned and divided into the original at least two powder materials).

Thus, a technique that enables a defined and reliable powder removal is desirable.

Furthermore, it is known that even with conventional beam melting (i.e. with a single material), particles can be deposited on the surface of the powder bed, for example weld spatter produced during the solidification of the material. Since these particles can cause interference during the subsequent application of the new powder layer and the solidification of this new powder layer, it is desirable to remove these particles from the powder bed.

Thus, it is desirable to have a technique that allows reliable removal of particles from a powder bed, particularly without removing a large additional amount of material.

It is therefore the object of the invention to provide a technique for removing powder and/or particles from a powder bed, which solves at least one of the problems described above or a related problem.

This problem is solved by an apparatus for removing powder and/or particles from a powder bed with the features of claim 1 and a method with the features of claim 15.

Accordingly, the invention relates according to a first aspect to an apparatus for removing powder and/or particles from a powder bed. The apparatus comprises a rotatably supported roller having a porous outer wall and a plurality of chambers formed within the roller. The apparatus further comprises a negative pressure supply port configured to supply a negative pressure to at least one of the chambers at a given time. The at least one of the chambers has an opening adapted to supply the chamber with the negative pressure.

The powder bed may be one or more layers of raw material powder applied to a carrier, in particular for the purpose of selective laser melting or selective laser sintering. The powder may comprise, for example, a metal powder, a ceramic powder and/or a plastic powder. In particular, the apparatus may be configured to remove different types of powder and, in particular, powder made of different materials. The removal can be done layer by layer.

The roller may be rotatably supported such that it can rotate relative to a support of the roller. The apparatus can comprise a drive, which is configured to cause the rotation of the roller. In particular, an electrically driven actuator may be provided for this purpose, for example a servo motor or a stepper motor. As an alternative to an electric drive, the roller can be set in its rotational motion by means of a negative pressure and/or positive pressure, using the ports for negative pressure or positive pressure described below. In a further alternative, the roller can be rolled mechanically over the powder bed, the rotary movement being brought about by friction between the powder bed and/or a building chamber floor extending next to the powder bed on the one hand, and the roller on the other.

If an electric drive is provided, a control unit may be provided which controls the electric drive. The control unit may be configured to drive the roller at an adjustable rotational speed. Further, the apparatus may comprise a horizontal movement device configured to move the roller horizontally across the powder bed (translatory movement). In this way, the roller can perform a rotational movement and a translatory movement. The horizontal movement device can comprise, for example, an electric actuator (e.g. motor). The horizontal movement device may also be controlled by the control unit.

The control unit may be configured to adjust the rotational movement of the roller and the translatory movement of the roller such that the translatory movement corresponds to the rotational movement on the outer wall of the roller. In this way, the roller can remove as thick a layer of powder as adheres to the roller as a result of the suction. Furthermore, the control unit can also control the rotation of the roller faster or slower, allowing different rotation speeds in relation to the translation speed. In this way, a quantity of powder can be adjusted, which is taken from the powder bed by the roller.

Furthermore, the apparatus can comprise a vertical movement device for adjusting a vertical position of the roller. The vertical position here corresponds to a height above the powder bed. The vertical movement device can preferably also be controlled by the control unit. The control unit can be configured to adjust a vertical position of the roller so that a height of a lower side of the roller corresponds to a height of the powder bed. The height of the roller thus corresponds to a height below which the roller rolls or would roll over the powder bed. In other words, the roller rests on the powder bed. However, the vertical position of the roller can also be adjusted so that there is a constant and predetermined distance between the roller and the powder bed during operation of the roller. In this case, the suction force of the roller can suck the powder over this distance. A further adjustment of the suction force is possible via a control of the negative pressure generation.

The above and the following explanations also apply to the suction of particles (in particular melt splashes) from the upper side of the powder bed. The roller can be configured to remove not only powder, but also larger particles from the surface of the powder bed. Furthermore, it is conceivable, that a height of the roller and/or a suction force is adjusted so that the roller removes primarily or even exclusively larger particles (i.e. particles larger than the powder used) from the surface of the powder bed.

The porous outer wall of the roller is porous in that it allows some gas to pass through, but is not permeable to powder and/or particles (above a certain diameter). For example, a smallest diameter of the powder can be 5 to 30 μm. The outer wall of the roller may be designed to have a pore size of less than 10 μm or less than 5 μm. Generally speaking, the pore size of the roller may be such that it does not allow the powder used to pass through. The roller may have as its porous outer wall some kind of surface filter, in particular a membrane or a coated fabric. The roller can further have several layers, such as a support grid located under the outermost layer and/or a coarse-pored structure, such as a sponge structure, for homogeneous pressure distribution on the outer wall.

In a preferred embodiment, the plurality of chambers formed within the roller are fixed to the roller. In this case, the plurality of chambers is fixedly connected to the roller in that rotational movement (i.e., rotational motion) of the roller causes rotational movement of the chambers therein. In other words, the plurality of chambers formed within the roller may be rotationally fixedly connected to the roller. The chambers thus rotate with the roller. The fixed connection thus does not mean that inner walls of the chambers must be mechanically connected to the outer wall of the roller (for example by welding, gluing, etc.). Rather, the fixed connection simply means that there is a rigid mechanical coupling between the roller and the chambers. This can also be achieved, for example, by fastening the outer wall of the roller and inner partitions of the chambers to one and the same rotatably supported shaft, or if the roller itself consists of a flexible medium stretched over the framework formed by the chambers.

As an alternative to rotationally fixedly connected chambers, the roller can also be movable independently of the chambers, and in particular the chambers in this case can be designed to be non-rotatable. In this case, the roller is rotated above the chambers. In addition, the roller can also be formed from a web of a flexible medium, which is driven above the chambers. For this purpose, a supporting grid structure can also be provided over which the web is moved.

For the purposes of the application, any bearing of the roller which returns the outer wall to its initial position along a closed path of movement is understood to be rotatably supported. It is easily recognizable that a roller in the sense of this application does not necessarily have to have a cylindrical shape, but can also have, for example, a polygonal cross-section, or, in the case of a material web, does not have to have a fixed shape on its own, but acquires this shape through the type of stretching.

The openings of the one or more chambers can be provided, for example, in the form of circular holes. The openings of the chambers may be located in a respective wall of the chamber that is not formed by the porous outer wall of the roller. For example, the openings of the chambers may be located in a wall of the respective chamber which delimits the elongated chamber at one end. Alternatively or additionally, the openings may be provided on an inwardly directed wall, such as a centrally located hollow shaft. Each of the chambers may have one or more (for example, two) openings.

The apparatus further comprises a negative pressure supply port configured to supply a negative pressure to at least one of the chambers at a given time. In this case, the negative pressure is supplied via the opening of the respective chamber.

The port may comprise a tube or a hose. The port may be configured to contact the opening of the respective chamber at the given time. As used herein, the term “given time” is intended to mean any time during a rotational movement of the roller. In this respect, the “given time” defines a snapshot and there exist, for example, previous and subsequent times at which another of the plurality of chambers may be contacted. The negative pressure may be suitable for drawing powder from the powder bed to the porous outer wall of the roller.

The chambers may extend along an axis of rotation of the roller, and each of the chambers may be delimited by a section of the porous outer wall.

The chambers are preferably defined by a volume and by walls (chamber walls) bounding that volume. A part of these chamber walls is formed by the porous outer wall of the roller, as defined above. In other words, each of the chambers may have a wall which is a section of the porous outer wall. In addition, one or more partition walls may be provided to delimit the plurality of chambers from one another. The chambers may thus be elongated along the axis of rotation of the roller. Each of the chambers may have a porous outer wall extending along the axis of rotation.

In the sense of the application, it is also possible that at least one chamber is provided which has only a very small volume, or even no volume at all, and thus forms an aperture chamber. The aperture chamber is then delimited by the porous outer wall on the one hand, and a solid wall on the other hand, which can be in direct contact with the porous outer wall. Preferably, the fixed wall can be stationary and the porous roller can be moved past the fixed wall. In this embodiment, the aperture chamber can have an extension along the roller circumference of more than 0.5 cm, in particular more than 1 cm, especially more than 3 cm. This can cause a lower negative pressure to prevail in the center of the aperture chamber than in an adjacent chamber.

The apparatus can further comprise a suction device for sucking off powder picked up by the roller, the suction device being arranged opposite one of the chambers of the roller which is not supplied with the negative pressure at the given time.

The suction device may comprise, for example, an opening for sucking the powder from the roller. Further, the suction device may be connected to a device for generating a negative pressure. This may be, for example, the same device that provides the negative pressure to the at least one chamber of the roller. The apparatus may further comprise a collection vessel for collecting the powder sucked off by the suction device. Further, the apparatus may comprise a separation device for separating the sucked off powder from the gas stream. The separated powder may be directed into the collection vessel. The collection vessel may further be formed by an overflow container, provided in the manufacturing device (plant) containing the suction device, for receiving excess powder applied during the layer generation. In addition to the suction device, the apparatus can have a brush or a comprise a brush or a scraper. The brush or the scraper is configured to detach the powder sucked onto the roller again, so that it can be sucked off by the suction device.

The negative pressure supply port can be fixedly connected to a support of the roller. The chambers can be rotationally fixedly connected to the roller, and each chamber can have an opening adapted to supply the chamber with a positive pressure or a negative pressure. The supply and the cambers may be designed in such a way that during the rotation of the roller the chambers are supplied with the negative pressure.

The apparatus may further comprise a positive pressure supply port configured to supply, at the given time, positive pressure to at least one of the chambers, which is not being supplied with the negative pressure at the given time, via its opening.

The positive pressure supply port may be fixedly connected to the support of the roller. The supply and the chambers can be designed in such a way that during the rotation of the roller the chambers are alternately supplied with the negative pressure and the positive pressure.

The chamber which is supplied with positive pressure at the given time can be located opposite the suction device. In this way, the powder is blown, so to speak, from the roller into the suction device. On the roller, which is thus freed from powder, new powder can now be sucked in and taken up by means of the negative pressure.

As mentioned above, the positive pressure supply port and the negative pressure supply port can be fixedly connected to a support of the roller and designed in such a way that during the rotation of the roller, the chambers are alternately supplied with the positive pressure and the negative pressure.

In other words, the rotational movement of the roller takes place relative to the negative pressure supply port and, if present, to the positive pressure supply port. Alternating supply of positive pressure and negative pressure means that any selected chamber is supplied with negative pressure at a given time, with positive pressure at a later time, and then with negative pressure again, and so on.

The apparatus can be designed in such a way that during the rotation of the roller, the opening of a chamber is contacted once by the negative pressure supply port, so that the respective chamber is supplied with the negative pressure, and once by the positive pressure supply port, so that the respective chamber is supplied with the positive pressure.

The apparatus can also be designed in such a way that a chamber has several different negative pressure supply ports and positive pressure supply ports.

The roller may be formed in the shape of a cylinder and the opening or openings may be provided in a base surface of the cylinder.

Thus, the opening or openings may be provided in the base surface at a first end of the roller. Additionally, for each of the chambers, a further opening may be provided in a further (opposite) base surface of the cylinder.

Alternatively to providing the openings in the base surface of the cylinder formed by the roller, the openings can be provided in the porous outer wall of the cylinder. They thus point radially outward. In this case, the ports can be built into the support of the roller and point radially inwards. As a further alternative, the openings of the chambers can be directed radially inwards (towards the axis of rotation of the roller). In this case, an inner axis rigidly connected to the support can be provided, in which a cavity for the negative pressure runs. The port for the negative pressure can thus point radially outward. Furthermore, a cavity for the positive pressure can run in the axis. The port for the positive pressure can thus point radially outward. The openings for negative pressure and positive pressure can also be provided on several of the protruding walls. The openings for the negative pressure can be provided in other or the same walls as openings for the positive pressure which are different therefrom. The openings for the negative pressure may be provided in the base surface of the roller cylinder at a first radius, and openings for the positive pressure different therefrom may be provided in the base surface of the roller cylinder at a second radius.

At least three chambers may be formed within the roller, wherein at least one chamber is always supplied with negative pressure and two chambers are supplied with negative pressure at least temporarily.

At least three chambers can be formed inside the roller, wherein the optional positive pressure supply port is designed to simultaneously supply several of the chambers with the positive pressure and/or wherein the negative pressure supply port is designed to simultaneously supply several of the chambers with the negative pressure. In particular, at least four chambers can be formed inside the roller.

For example, eight chambers may be provided within the roller. At any given time, several of the chambers (i.e., at least two) are simultaneously supplied with the negative pressure. Further, at least one of the chambers may be supplied with the positive pressure at any point in time. There may also remain one or more chambers which are not supplied with negative pressure or positive pressure and which thus have an atmospheric pressure or maintain their previous pressure state. The atmospheric pressure can be a pressure within a build chamber of a system for producing a three-dimensional workpiece.

The optional positive pressure supply port may have an elongated hole that simultaneously exposes the openings of several chambers. The negative pressure supply port can have an elongated hole that simultaneously exposes the openings of several chambers.

The openings of the chambers can be circular. By uncovering is meant the opposite of covering. In other words, the respective uncovered openings can be contacted by the respective port and thus be supplied with negative pressure or positive pressure. The elongated hole may be curved, in particular along a circular arc.

The apparatus may further comprise a shaft extending within the roller, wherein the plurality of chambers are formed by a plurality of grooves formed in the shaft.

Preferably, the chambers may be of equal size. Preferably, the walls located between the chambers are as thin as possible, in particular less than 5 mm, 3 mm, or 1 mm thick, at least in the region of the transition to the porous outer wall.

In an apparatus with non-rotating chambers and a roller moving above the chambers, the chambers may have different sizes. Furthermore, only one chamber can be permanently supplied with negative pressure. Further, only one chamber or no chamber can be supplied with positive pressure.

The apparatus may further comprise a negative pressure generating device connected to the negative pressure supply port and adapted to generate a negative pressure at least during operation of the apparatus.

The negative pressure generating device may be, for example, a vacuum pump. The device may further be connected to other components of a system for producing a three-dimensional workpiece, which require a negative pressure.

The apparatus may further comprise a positive pressure generating device connected to the positive pressure supply port and adapted to generate a positive pressure at least during operation of the apparatus.

The positive pressure generating device may be, for example, a pump or a blower. The device may further be connected to further components of a system for producing a three-dimensional workpiece, which require a positive pressure.

According to a second aspect, there is provided a system for producing a three-dimensional workpiece comprising the apparatus for removing powder and/or particles from a powder bed according to the first aspect. More specifically, the system comprises a carrier for receiving powder in a plurality of layers to form a powder bed, at least one powder application device for applying the powder to the carrier, and at least one irradiation unit for irradiating an uppermost powder layer of the powder bed at predetermined positions, and the apparatus for removing powder and/or particles from a powder bed according to the first aspect.

The system for producing a three-dimensional workpiece may be a selective laser melting system or a selective laser sintering system, with the usual elements and functions of such a system. The system for producing a three-dimensional workpiece comprises, for example, a carrier for applying the powder in multiple layers so-as to form the powder bed. Furthermore, one or more powder application devices can be provided, for applying the powder and, if necessary, for applying powders of different materials. A separate powder application device can be provided for each material. The carrier can be moved vertically downwards by means of a vertical movement device, so that the uppermost layer of powder always remains at the same height in relation to a build chamber of the system. Further, the system may comprise one or more irradiation units. The irradiation units each comprise a beam source (in particular a laser beam source) and an optical system with one or more optical components for shaping and deflecting the beam (e.g. beam expander, focusing unit, scanner, F-theta lens).

Further, the system may comprise a control unit configured to control the components of the system. In particular, the control unit may be configured to control the apparatus for removing powder (for example, to control a rotational movement and/or a translatory movement of the roller).

The apparatus for removing powder can be arranged in a build chamber of the system. In particular, the apparatus can be coupled to a powder application device. The coupling can be designed in such a way that the apparatus for removing powder can be moved together with the powder application device (horizontally and/or vertically).

In other words, the apparatus can be coupled to the powder application device, and the system can comprise a movement device, which is configured to move the apparatus and the powder application device together.

In particular, the system may comprise a cleaning station for cleaning the apparatus for removing powder. The cleaning station may be positioned so that the apparatus for removing powder can be moved to and cleaned at the cleaning station. For this purpose, the cleaning station can comprise, for example, one or more nozzles by means of which the roller of apparatus for removing powder can be blown off and freed from powder. Alternatively or additionally, the cleaning device can also have a suction device for sucking off the roller, as well as scrapers, brushes or similar mechanical cleaning devices.

The chamber, which is supplied with a negative pressure, can be located on a side of the roller facing the powder bed.

In particular, the chamber supplied with a negative pressure can be in contact with the powder bed, or at least be arranged directly opposite the powder bed, during operation of the device, and thus suck in powder so that it adheres to the porous outer wall of the roller. The apparatus may be configured in such a way that more than one chamber is supplied with the negative pressure at the given time.

According to a third aspect, the invention relates to a method for removing powder and/or particles from a powder bed. The method comprises rotating a rotatably supported roller having a porous outer wall. The roller has a plurality of chambers formed within the roller. At least one of the chambers has an opening adapted to provide the chamber with a negative pressure. The method further comprises supplying the at least one chamber with a negative pressure via its opening. In particular, each of the chambers may have an opening.

All aspects discussed in connection with the apparatus or system described above may also be applied to the method of the third aspect. In other words, the apparatus of the first aspect and/or the system of the second aspect may be configured to perform the method of the third aspect.

With respect to removing the powder, the method may further comprise one or more of the following aspects. Powder is sucked from the powder bed by the negative pressure of the chamber supplied with the negative pressure. The sucked powder remains adhered to the porous outer wall of the roller, at least as long as the negative pressure is maintained. While the negative pressure is maintained, the powder is sucked to the section of the porous outer wall of the roller, which forms a wall of the chamber. The sucked powder does not penetrate into the interior of the roller due to the selected pore size. During the rotational movement of the roller, the powder continues to be sucked in, until a point in time (i.e. until a position of the roller), where the respective chamber is no longer supplied with negative pressure. The powder, which is now no longer sucked in, is extracted by a suction device and, if necessary, additionally brushed or scraped off the roller. In addition, a positive pressure can be applied to the opening of the respective chamber, which was previously supplied with a negative pressure, which facilitates the extraction by the suction device. The collected powder is thus blown into the suction device. The respective section of the roller is now freed from powder again and ready to receive new powder from the powder bed. Depending on how fast the rotation of the roller is controlled in relation to its translation, the amount of powder picked up can be adjusted. In addition or as an alternative to powder, particles (e.g., weld spatter) can be removed from the powder bed.

The chambers may extend along an axis of rotation of the roller, and each of the chambers may be bounded by a portion of the porous outer wall.

Supplying at least one of the chambers with negative pressure via its opening may be accomplished at a given time via a negative pressure supply port.

The chamber supplied with a negative pressure may be located on a side of the roller facing the powder bed.

The method may further comprise a suction of powder picked up by the roller by a suction device, the suction device being arranged opposite one of the chambers of the roller which is not supplied with the negative pressure at the given time.

The method may further comprise supplying at least one of the chambers, which is not supplied with the negative pressure at the given time, with a positive pressure at the given time, via its opening.

The positive pressure supply port and the negative pressure supply port may be fixedly connected to a support of the roller, and the method may further comprise alternately supplying the chambers with the positive pressure and the negative pressure during rotation of the roller.

The method may further comprise rotating the roller such that during rotation of the roller, the opening of a chamber is contacted once by the negative pressure supply port such that the respective chamber is supplied with the negative pressure and is contacted once by the positive pressure supply port such that the respective chamber is supplied with the positive pressure.

The roller may be formed in the shape of a cylinder and the openings may be provided in a base surface of the cylinder.

At least three chambers may be formed within the roller. The method may comprise simultaneously supplying positive pressure to several of the chambers via the positive pressure supply port. The method may comprise simultaneously supplying negative pressure to several of the chambers via the negative pressure supply port.

The positive pressure supply port may have an elongated hole that simultaneously exposes the openings of several chambers. The connection for negative pressure supply can have an elongated hole which simultaneously exposes the openings of several chambers.

The invention is explained below with reference to the accompanying figures. They represent:

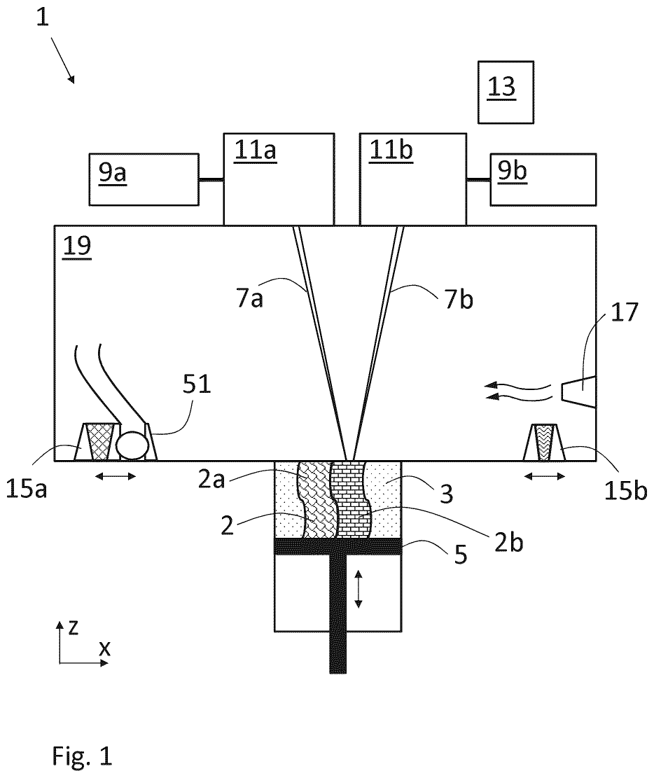

FIG. 1: a perspective side view of a system for producing a three-dimensional object with an apparatus for removing powder and/or particles from the powder bed of the system, according to an embodiment of the present disclosure;

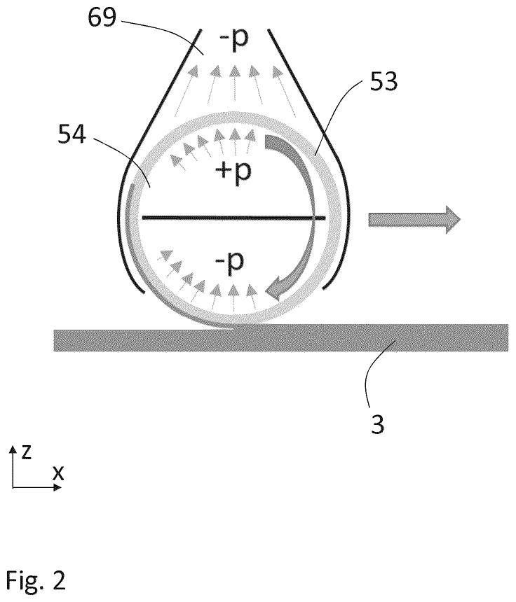

FIG. 2: a schematic side view of an apparatus for removing powder and/or particles from a powder bed, explaining the principle of the technique of the present disclosure;

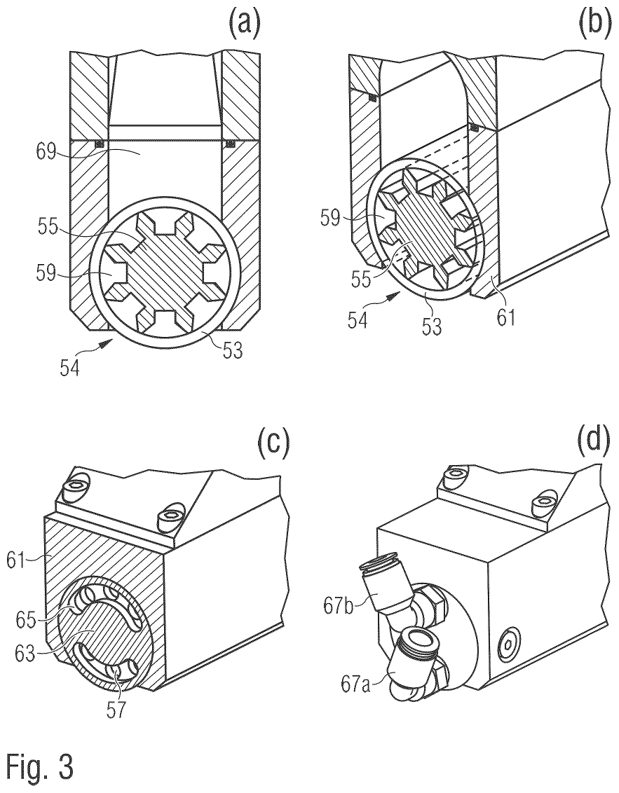

FIG. 3(a): a cross-sectional view of an apparatus according to an embodiment of the present disclosure;

FIG. 3(b): a perspective sectional view of the apparatus of FIG. 3(a);

FIG. 3(c): a perspective view of the apparatus of FIG. 3(a) with a control disc comprising elongated holes for connecting negative pressure and positive pressure, respectively;

FIG. 3(d): a perspective view of the apparatus of FIG. 3(a) with pipe connectors for connecting the negative pressure and the positive pressure;

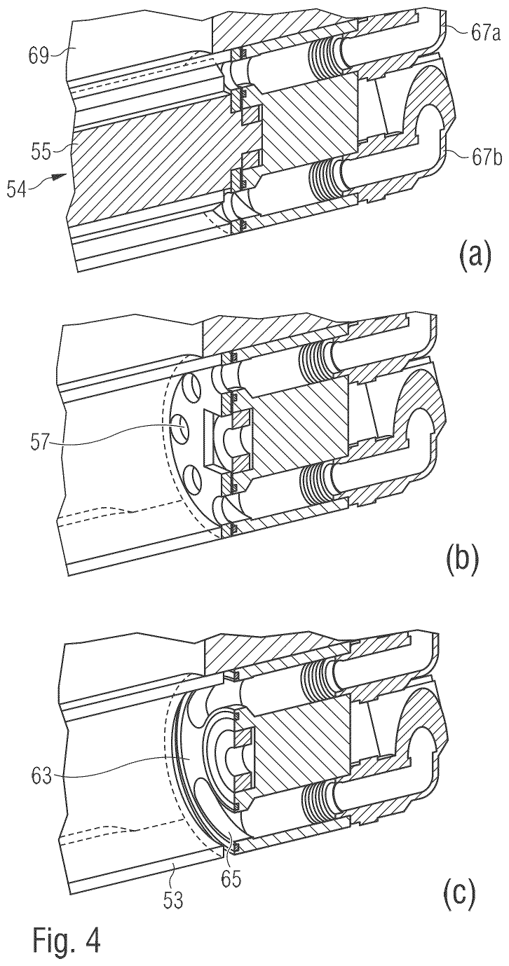

FIG. 4(a): a perspective sectional view of the apparatus of FIG. 3(a) with a shaft with grooves, a perforated disc with openings and a control disc with elongated holes;

FIG. 4(b): a perspective sectional view of the apparatus of FIG. 3(a) similar to the view of FIG. 4(a), with the shaft with grooves removed;

FIG. 4(c): a perspective sectional view of the apparatus of FIG. 3(a) similar to the view of FIG. 4(b), with the perforated disc with openings removed; and

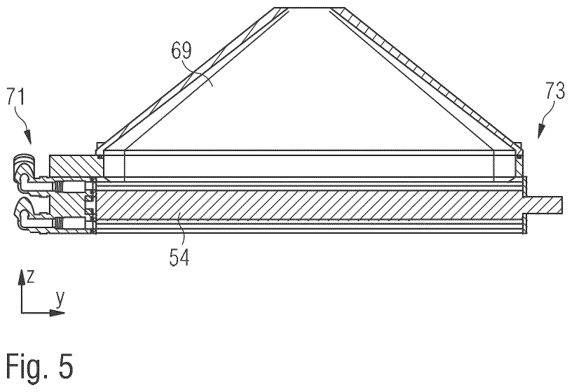

FIG. 5: a sectional view of the apparatus of FIG. 3(a) along an axis of rotation of the roller.

In FIG. 1, a system 1 for producing a three-dimensional object 2 is shown, wherein the system 1 comprises an apparatus 51 for removing powder and/or particles from the powder bed 3 of the system 1. Apart from the apparatus 51, the system 1 is a conventional system for selective laser melting with the known components. The selective laser melting technique used by the system 1 is well known to the person skilled in the art and will only be briefly explained here on the basis of the selective laser melting in the powder bed 3.

First, a first layer of raw material powder is applied to a carrier 5 of the system 1 and is illuminated in a site-specific manner by one or more laser beams 7a, 7b in such a way that desired areas of the powder are solidified. The present example shows a system 1 with two irradiation units, each comprising a laser 9a, 9b and an optical system 11a, 11b. Thus, the irradiation unit comprising the laser 9a and the optical system 11a is configured to emit the laser beam 7a and to direct it to a desired location of an uppermost powder layer of the powder bed 3. Further, the irradiation unit comprising the laser 9b and the optical system 11b is configured to emit the laser beam 7b and to direct it to a desired location of the uppermost powder layer of the powder bed 3. The optical systems 11a, 11b each comprise components for beam shaping and beam deflection, such as lenses, deflection mirrors, scanner mirrors, etc.

All components of the system 1 are controlled by a control unit 13, in particular the lasers 9a, 9b, the scanner mirrors of the optical systems 11a, 11b, the movement of the carrier 5 and the functions of the powder application devices 15a, 15b and the apparatus 51 described further below.

After the first layer of powder has been solidified as desired, another layer of powder is applied to the previous powder layer, and again illumination and solidification of this uppermost layer occurs.

In order to keep a distance between the uppermost layer and the optical units always constant, it is possible to lower the carrier 5 and/or raise the optical units (along a vertical direction defined herein as the z-direction) during the ongoing building process. In this way, the three-dimensional workpiece 2 to be produced is built up layer by layer. Subsequently, the unsolidified powder can be removed and, if necessary, reused.

A special feature of the system 1 shown in FIG. 1 is that the workpiece 2 is built up from two components 2a, 2b, for which two different powder materials are used. The powder materials can differ, for example, by the powder material used, but also by the grain size of the respective powder used.

In order to build up the workpiece consisting of two components 2a and 2b, per workpiece layer, first a layer of a first powder material is applied, for which a first powder application device 15a is used. Subsequently, the areas of the respective layer of the workpiece 2, which are to be formed from the first powder, are solidified with the laser beams 7a, 7b. In a next step, the first powder material is removed again from the powder bed 3. For this purpose, the apparatus 51 is used. Subsequently, the second powder is applied with the aid of a second powder application device 15b and the areas of the layer of the workpiece 2 previously irradiated for the first powder that are to be made of the second powder material are solidified. In a subsequent step, the carrier 5 is lowered and a new layer of the first powder is applied by the first powder application device 15a.

As indicated by the double arrows in FIG. 1, the two powder application devices 15a and 15b are movable horizontally over the powder bed 3 in order to apply the respective powder. In the example shown, the apparatus 51 is fixedly connected to the first powder application device 15a and is moved together with it. On the one hand, this has the advantage that the apparatus 51 does not require an additional movement device, since it can be moved with the movement device or movement devices of the first powder application device 15a (horizontal movement device and, optionally, vertical movement device). A further advantage can be that a height calibration (i.e. calibration along the z-axis) between powder application device 15a and apparatus 51 can be omitted. Further, if required in the process, powder can be removed by the apparatus 51 and powder can be applied by the powder application device 15a simultaneously (when the devices 15a and 51 are moved to the right along the positive x-direction in the illustration of FIG. 1 and operated simultaneously).

A gas supply 17 supplies inert gas to a build chamber 19 of the system 1, such that an inert gas atmosphere exists within the build chamber 19. Further, a gas extraction system (not shown) may be provided to draw the inert gas back out of the build chamber 19 so that a gas flow through the build chamber 19 (particularly over the powder bed 3) is generated.

In addition or as an alternative to the possibility described above of removing a powder layer during building using two powder materials, the apparatus 51 can be used to remove particles from the surface of the powder bed 3. In particular, this may be weld spatter produced during the solidification of the powder by the laser beams 7a, 7b.

In the following, the apparatus 51 for removing powder and/or particles from a powder bed 3 is explained in detail.

FIG. 2 shows a schematic side view of the apparatus 51 for removing powder and/or particles from a powder bed 3. With the aid of FIG. 2, the principle of the technique of the present disclosure can be explained.

The basic principle of the apparatus 51 (hereinafter also referred to as “suction roller”) is that a porous (in particular microporous) tube (e.g. consisting of sintered material or fabric such as felt or a tube with fine holes) picks up and releases powder in a defined manner with the aid of internal pressure differences. The porous tube constitutes a porous outer wall 53 of a roller 54.

In operation, the roller 54 rolls over the powder bed 3 at a very short distance, performing a combined rotational movement and translatory movement, producing a “cutting” speed as in machining (e.g., milling). In other words, the rotational speed and the translatory speed of the roller 54 are arbitrarily adjustable by the control unit 13. For example, these speeds can be set so that the translatory speed corresponds to the rotational speed at which the outer wall 53 of the roller 54 rolls over the powder bed. In this way, exactly one layer of powder can be removed. However, the roller 54 can also rotate faster or slower in relation to the translation, which makes it possible, for example, to control the amount of powder removed.

The powder is picked up by a negative pressure (“−p”) inside the roller 54 in the lower area, which sucks the powder particles out of the powder bed 3. The particles are caught in the porous tube 53 and thus limit the local pick up capacity of the roller 54, so that only a defined layer depth is picked up. In the upper area, there is an optional overpressure area (“+p”) within the roller 54, which ensures that the picked up powder particles are ejected from the roller 54. In addition, above the roller 54 there is a suction funnel (in the following also: suction device 69) with a negative pressure flow (“−p”), which removes the ejected powder.

The negative pressure area and the positive pressure area are separated by a fixed wall 52 into two chambers of approximately equal size. The roller 54 is formed by a rotating porous outer wall 53.

As an alternative to the principle described above with a positive pressure area (“+p”), the positive pressure area can also be omitted and replaced, for example, by an area in which atmospheric pressure prevails. By atmospheric pressure is meant here a pressure within the build chamber 19 of the system 1. Furthermore an additional means for removing the powder in the region of the suction device 69 be provided, for example a brush or a scraper.

FIGS. 3(a) to (d) show different views of an apparatus 51 for removing powder and/or particles from a powder bed 3.

FIG. 3(a) shows a cross-section through the roller 54 perpendicular to its axis of rotation. FIG. 3(b) shows a perspective sectional view, and FIGS. 3(c) and 3(d) show perspective views on which further components of the apparatus 51 are shown.

The pressure ranges shown in FIG. 2 are achieved within the roller 54 by a multi-chamber design. The core of the roller 54 consists of a longitudinally grooved shaft 55, on which the porous tube is seated as the porous outer wall 53 of the roller 54. The shaft 55 rotates together with the roller 54 and thus together with the porous outer wall 53. In other words, the chambers 59 formed within the roller 54 retain “their” section of the porous outer wall 53 of the roller 54. The position of the chambers 59 relative to the outer wall 53 of the roller 54 thus remains unchanged.

The walls between the chambers 59 are as narrow as possible at their transition to the porous outer wall 53. This also generates sufficient negative pressure in the area of the walls on the outer wall.

A lower area of the roller 54 faces the powder bed 3 and chambers 59, which are located in this lower area, are supplied with the negative pressure. Adjacent to an upper area of the roller 54 is a suction device 69, by means of which the powder sucked onto the outer wall 53 of the roller 54 can be sucked off again and fed to a collecting vessel (not shown). The chambers 59, which are opposite the suction device 69, are supplied with a positive pressure in the present embodiment. Alternatively, atmospheric pressure can prevail in them.

At the end of the roller 54 there is a plate (perforated plate) with openings 57 (e.g. bores, see FIG. 3(c)) at the locations where the grooves of the shaft 55 end. This plate is connected to the roller 54 and rotates with the roller 54. In the housing, which is a support 61 for the roller 54, a so-called control disc 63 adjoins the perforated plate. The control disc 63 forms part of a positive pressure port and a negative pressure port. Inside the control disc 63 there are two bent elongated holes 65. The elongated holes 65 are bent along a circular arc, a center of the circular arc forming a point of intersection of the axis of rotation of the roller 54 with the control disc 63. The elongated holes 65 are each formed such that, at a given time, a several of the openings 57 are simultaneously exposed. Thus, at the given time, several of the chambers 59 can be supplied with a negative pressure. Likewise, several of the chambers 59 can be supplied with a positive pressure at the same time.

The elongated holes 65 are contacted via tube connectors 67a, 67b (see FIG. 3(d)).

In the figures, for reasons of clarity, not all of the above-mentioned elements are provided with their own reference sign, but in some cases only one of the elements (e.g. only one of the chambers 59 is provided with its own reference sign).

Furthermore, according to an embodiment, the positive pressure supply port can be omitted and instead a port to the atmosphere can be provided. For this purpose, for example, the upper pipe connector 67b can remain open towards the atmosphere.

In this regard, it should be noted that the pipe connector 67a of the negative pressure supply port is connected to a device for generating a negative pressure (not shown), for example by means of a pipe or hose. This device can be understood as part of the apparatus 51. The device for generating a negative pressure may, for example, be a vacuum pump. This may be a vacuum pump which also supplies other elements of the system 1 with a negative pressure. Similarly, the pipe connector 76b of the positive pressure supply port is connected to a device for generating a positive pressure (not shown), for example by means of a pipe or hose. This device can be understood as part of the apparatus 51. The device for generating a positive pressure may, for example, be a pump or a blower. This may be a pump which also supplies other elements of the system 1 with a positive pressure.

The entire apparatus 51 with housing (support 61) and suction device 69 is mounted on the powder application device 15a and is moved together with it over the powder bed 3.

FIGS. 4(a) to (c) show further sectional views of the apparatus 51 of FIGS. 3(a) to (d). For improved clarity, in FIG. 4(b) the shaft 55 has been removed and in FIG. 4(c) the perforated plate with the openings 57 of the chambers 59 has additionally been omitted. Between the perforated plate with the openings 57 and the control disc 63, there can be a seal (e.g. in the form of a Teflon ring), which prevents powder from the powder bed from penetrating into the interior of the roller and/or the negative pressure line.

FIG. 5 shows a section through the apparatus 51 of FIGS. 3(a) to (d) along an axis of rotation of the roller 54. In FIG. 5, it can be seen that the suction device 69 has a funnel-shaped section.

It can also be seen that the negative pressure and positive pressure ports are arranged at one end 71 of the roller 54. At the other, opposite end 73 of the roller 54, an actuator (e.g. servo motor or stepper motor, not shown) is provided which drives the rotation of the roller 54. The actuator is controlled by the control unit 13.

As an alternative to an electrically operated actuator, the roller 54 can be driven by the pressure differences provided by the respective ports for negative pressure and positive pressure. Furthermore, the roller 54 can be rolled over the powder and set in rotation by means of the resulting friction.

In operation, the apparatus 51 removes a defined amount of powder from the powder bed 3 in the following manner.

The chambers 59, which are located in the lower area of the roller 54 facing the powder bed 3, are supplied with a negative pressure by means of the control disc 63 (more precisely, via the elongated holes 65 of the control disc 63). As can be seen in FIG. 3(c), for example, three chambers 59 can be contacted simultaneously and supplied with negative pressure. At the porous outer walls 53 of these chambers 59 (i.e., at the areas of the porous outer wall 53 which form the outer walls of these chambers 59), powder is sucked out of the powder bed 3. A powder layer of a defined thickness forms on the roller 54. The sucked powder is transported by the rotation of the roller 54 into the interior of the apparatus 51 and transported in the direction of the suction device 69. On this path, the chambers 59 lose their negative pressure and are then supplied with positive pressure through the upper elongated hole 65 of the control disc 63. The sucked powder is thus blown off the roller 54. This takes place in an (upper) area of the apparatus 51, where the suction device 69 is located. There, the powder is sucked off and fed to a collection vessel (not shown).

The roller 54, thus freed from powder again, continues to rotate and can pick up new powder from the powder bed 3.

As described above, the two elongated holes 65 of the control disc 63 are designed in such a way that they can simultaneously supply several of the chambers 59 with negative pressure or with positive pressure. In an alternative embodiment, only one chamber 59 is supplied with negative pressure and only one chamber 59 with positive pressure at any given time.

Furthermore, any number of ways of contacting the chambers 59 with negative pressure or with positive pressure are possible. In the illustrated embodiment, the roller 54 is contacted via a base surface of the cylinder formed by the roller 54.

Alternatively, contacting in the support 61 can be achieved by ports directed inwards (towards the roller 54). As a further alternative, the roller 54 can be rotated on an axle which is fixedly connected to the support 61. The axle has a cavity for contacting one or more of the chambers 59 with a negative pressure. For this purpose, the cavity has one or more radially outwardly directed openings. Similarly, there may be a cavity in the axle for contacting one or more of the chambers 59 with positive pressure. This cavity also has one or more radially outwardly directed openings.

With the technology described above, it is possible to reliably remove a defined quantity of powder from a powder bed. Alternatively or additionally, particles such as weld spatter can be removed.

1-15. (canceled)

16. Apparatus for removing powder and/or particles from a powder bed, comprising:
a rotatably supported roller having a porous outer wall;
a plurality of chambers formed within the roller; and
a negative pressure supply port configured to supply a negative pressure to at least one of the chambers at a given time, the at least one of the chambers having an opening adapted to supply the chamber with the negative pressure.

17. Apparatus according to claim 16, wherein the chambers extend along an axis of rotation of the roller and each of the chambers is delimited by a section of the porous outer wall.

18. Apparatus according to claim 16, further comprising:
a suction device for sucking off powder picked up by the roller, the suction device being arranged opposite one of the chambers of the roller which is not supplied with the negative pressure at the given time.

19. Apparatus according to claim 16, wherein the negative pressure supply port is fixedly connected to a support of the roller, and wherein the chambers are rotationally fixedly connected to the roller and each chamber has an opening adapted to supply the chamber with a positive pressure or a negative pressure, and the supply and the chambers are designed in such a way that during the rotation of the roller the chambers are supplied with the negative pressure.

20. Apparatus according to claim 19, further comprising:
a positive pressure supply port configured to supply, at the given time, positive pressure to at least one of the chambers, which is not supplied with the negative pressure at the given time, via its opening.

21. Apparatus according to claim 20, wherein the positive pressure supply port is fixedly connected to the support of the roller, and wherein the supply and the chambers are designed in such a way that during the rotation of the roller the chambers are alternately supplied with the negative pressure and the positive pressure.

22. Apparatus according to claim 21, wherein the apparatus is designed in such a way that during the rotation of the roller the opening of a chamber is contacted once by the negative pressure supply port, so that the respective chamber is supplied with the negative pressure, and is contacted once by the positive pressure supply port, so that the respective chamber is supplied with the positive pressure.

23. Apparatus according to claim 16, wherein the roller is formed in the shape of a cylinder and the opening or openings is/are provided in a base surface of the cylinder.

24. Apparatus according to claim 20, wherein at least three chambers are formed within the roller,
wherein the positive pressure supply port is configured to simultaneously supply several of the chambers with the overpressure and/or
wherein the negative pressure supply port is configured to simultaneously supply several of the chambers with the negative pressure.

25. Apparatus according to claim 20,
wherein the positive pressure supply port has an elongated hole which simultaneously exposes the openings of several chambers and/or
wherein the negative pressure supply port has an elongated hole which simultaneously exposes the openings of a several of chambers.

26. Apparatus according to claim 16, further comprising:
a shaft extending within the roller, wherein the plurality of chambers is formed by a plurality of grooves formed in the shaft.

27. System for producing a three-dimensional workpiece, comprising:
a carrier for receiving powder in multiple layers so that a powder bed is formed,
at least one powder application device for applying the powder to the carrier and
at least one irradiation unit for irradiating an uppermost powder layer of the powder bed at predetermined positions, and
the apparatus for removing powder and/or particles from a powder bed according to claim 16.

28. System according to claim 27, wherein the apparatus is coupled to the powder application device, and wherein the system comprises a movement device which is configured to move the device and the powder application device together.

29. System according to claim 28, wherein the chamber, which is supplied with a negative pressure, is located on a side of the roller facing the powder bed.

30. A method for removing powder and/or particles from a powder bed, comprising:
rotating a rotatably supported roller having a porous outer wall, the roller having a plurality of chambers formed within the roller, at least one of the chambers having an opening adapted to provide the chamber with a negative pressure; and
supplying the at least one chamber with the negative pressure via its opening.
